(19) United States
(12) Patent Application Publication
(10) Pub. No.: US 2010/0194877 A1
(43) Pub. Date: Aug. 5, 2010

(54) METHOD AND SYSTEM FOR IMAGING AN ELECTRICAL CIRCUIT

(76) Inventor: Menachem Regensburger, Shimshit (IL)

Correspondence Address: SAMUEL L. JAMES JR., 77 DREXEL RD., BUFFALO, NY, 14214, US

(21) Appl. No.: 12/526,783

(22) PCT Filed: Feb. 12, 2008
(86) PCT No.: PCT/IL08/00181

§ 371 Date: Apr. 13, 2010

Related U.S. Application Data
(60) Provisional application No. 60/890,629, filed on Feb. 20, 2007.

(51) Int. Cl. H04N 7/18

(52) U.S. Cl. 348/87; 348/E07.085

(57) ABSTRACT

A system and a method for imaging an electrical circuit, the method includes: selectively activating an image sensor and introducing a mechanical movement between the electrical circuit and the image sensor so as to acquire multiple mutually parallel strips of elongated irregular hexagonal frames of portions of the electrical circuit; wherein two elongated edges of each elongated irregular hexagonal frame are substantially longer than other edges of the elongated irregular hexagonal frame.

### RELATED APPLICATIONS

This application claims the priority of U.S. provisional patent application Ser. No. 60/890,629 filing date 20 Feb. 2007.

### FIELD OF THE INVENTION

The invention relates to methods for imaging an electrical circuit and especially relates to a high throughput system and method for imaging a wafer.

### BACKGROUND OF THE INVENTION

Electrical circuits such as but not limited to printed circuit boards, masks or wafers are inspected during various stages of their manufacturing. The inspection can involve: (i) moving the electrical circuit in relation to an image sensor, (ii) acquiring multiple square shaped images (also referred to as frames) of different portions of the electrical circuit, and (iii) processing these images. The processing is usually based upon comparisons of ideally identical elements.

Typically, the electrical circuit is placed on a heavy mechanical stage that moves the electrical circuit during the inspection process. The mechanical stage can move along a so-called raster pattern by repeating the following movements: (i) moving the electrical circuit along a scan direction, (ii) moving the electrical circuit along a non-scan direction that is typically perpendicular to the scan direction, (iii) moving the electrical circuit along an opposite scan direction, and (iv) moving the electrical circuit along the non-scan direction.

Stripes of square shaped frames are acquired when the electrical circuit is moved along the scan direction and along the opposite scan direction. The movements along the non-scan direction are required in order to obtain spaced apart (or at least not fully overlapping) stripes.

The change from movement along the scan direction (or the opposite direction) to a movement along the non-scan direction and vice verse is time consuming, especially when using a heavy mechanical stage and when the mechanical movements should be very accurate.

Accordingly, there is a need to reduce the number of changes in the direction of mechanical movements that are required for scanning an electrical circuit.

There is a need to provide efficient methods and systems for imaging electrical circuits.

### SUMMARY OF THE INVENTION

A method for imaging an electrical circuit, the method includes: selectively activating an image sensor and introducing a mechanical movement between the electrical circuit and the image sensor so as to acquire multiple mutually parallel strips of elongated irregular hexagonal frames of portions of the electrical circuit; wherein two elongated edges of each elongated irregular hexagonal frame are substantially longer than other edges of the elongated irregular hexagonal frame.

A system for imaging an electrical circuit, the system includes an image sensor and a movement introducer; wherein the image sensor is selectively activated while the movement introducer introduces a mechanical movement between the electrical circuit and the image sensor so that the image sensor acquires multiple mutually parallel strips of elongated irregular hexagonal frames of portions of the electrical circuit; wherein two elongated edges of each elongated irregular hexagonal frame are substantially longer than other edges of the elongated irregular hexagonal frame.

### BRIEF DESCRIPTION OF THE DRAWINGS

The present invention will be understood and appreciated more fully from the following detailed description taken in conjunction with the drawings in which:

FIG. 1 illustrates a regular hexagonal frame and an elongated irregular hexagonal frame according to an embodiment of the invention;

FIG. 2 illustrates partially overlapping elongated irregular hexagonal frames according to an embodiment of the invention;

FIG. 3 illustrates non-overlapping elongated irregular hexagonal frames according to an embodiment of the invention;

FIG. 4 illustrates a raster pattern and elongated irregular rectangular frames according to an embodiment of the invention;

FIG. 5 illustrates another raster pattern and regular rectangular frames according to an embodiment of the invention;

FIG. 6 illustrates a method for imaging an electrical circuit according to an embodiment of the invention; and

FIG. 7 illustrate a system according to an embodiment of the invention.

### DETAILED DESCRIPTION OF THE DRAWINGS

A system and a method for imaging an electrical circuit are provided. The number of stripes that are required for imaging the electrical circuit is reduced and the utilization of an image sensor is increased by acquiring elongated irregular hexagonal frames.

Conveniently, the methods and systems can utilize existing hardware and do not require costly modifications.

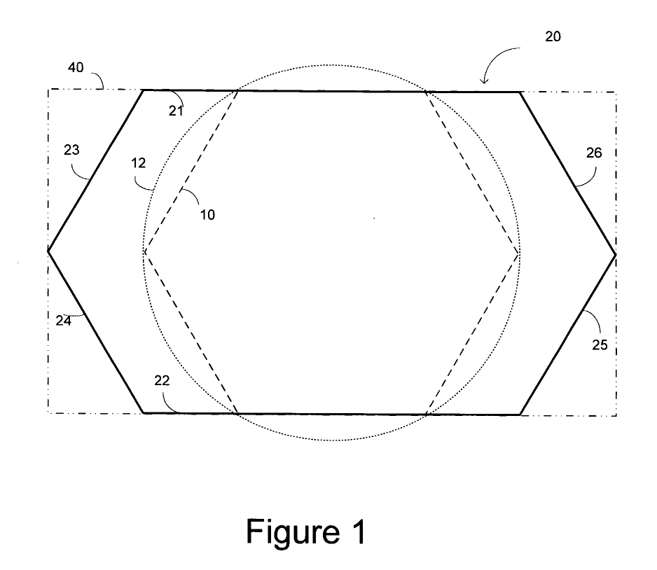

FIG. 1 illustrates regular hexagonal frame 10 and elongated irregular hexagonal frame 20 according to an embodiment of the invention. Regular hexagonal frame 10 has six edges that are equal to each other. It is blocked by imaginary circle 12. An angle of sixty degrees is defined between an edge that starts at certain vertex and a diagonal that extends from that vertex to an opposite vertex.

Elongated irregular hexagonal frame 20 is longer than regular hexagonal frame 10 and includes two elongated edges 21 and 22 that are substantially longer than other edges (23, 24, 25 and 26) of elongated irregular hexagonal frame 20. Elongated edges 21 and 22 are longer than the edges of regular hexagonal frame 10.

Conveniently, elongated irregular hexagonal frame 20 is shaped so as to be entirely imaged onto a rectangular array of image sensors within an image sensor. This is illustrated by rectangular 40 that blocks elongated irregular hexagonal frame 20. Conveniently, elongated edges 21 and 22 are parallel to the longer edges of rectangular 40.

The acquisition of elongated irregular hexagonal frames allows to reduce the number of strips (in comparison to acquiring rectangular frames) while better utilizing known optics that can image a circular shaped area and a rectangular shapes image sensor.

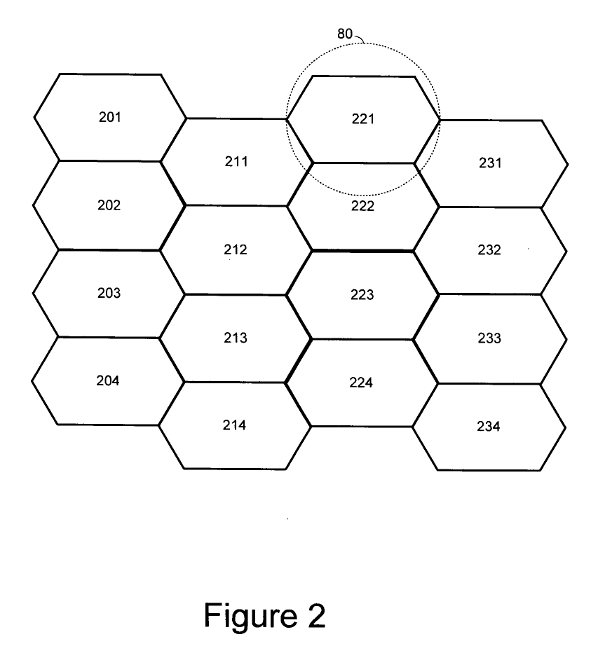

Conveniently, different elongated irregular hexagonal frames do not overlap, as illustrated by elongated irregular hexagonal frames 201, 202, 203, 204, 211, 212, 213, 214, 221, 222, 223, 224, 231, 232, 233 and 234 of FIG. 2. FIG. 2 also illustrates the circular shaped area 80 that is imaged by optics.

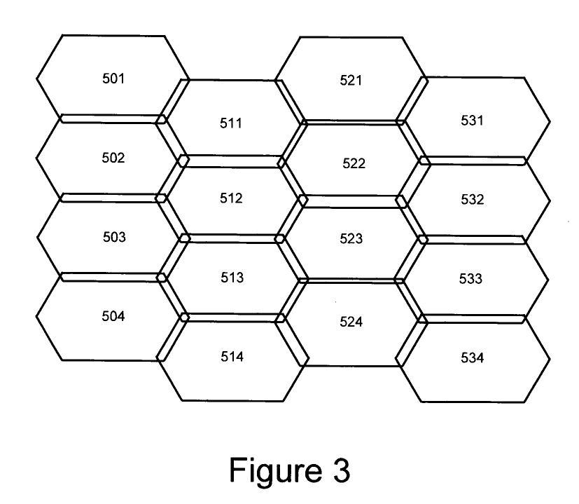

Conveniently, different elongated irregular hexagonal frames slightly overlap, as illustrated by elongated irregular hexagonal frames 501, 502, 503, 504, 511, 512, 513, 514, 521, 522, 523, 524, 531, 532, 533 and 534 of FIG. 3. It is noted that the corresponding elongated irregular hexagonal frames of different stripes can partially overlap (see for example—the overlap between elongated irregular hexagonal frames 202 and 212). Additionally or alternatively, adjacent elongated irregular hexagonal frames of the same stripe can partially overlap (see for example—the overlap between elongated irregular hexagonal frames 202 and 203).

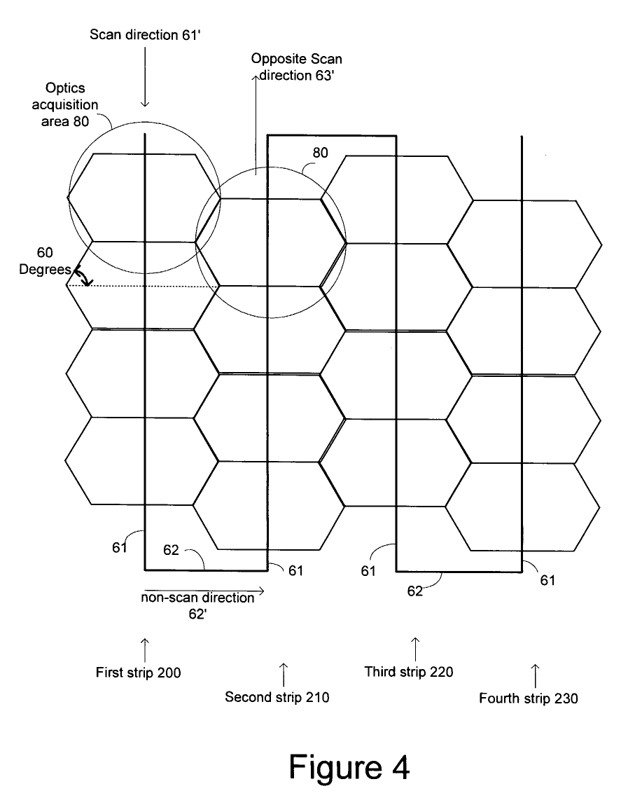

Conveniently, the acquisition of elongated irregular hexagonal frames can utilize substantially the same mechanical scanning scheme that is used when acquiring rectangular frames. In comparison, if regular hexagonal frames were acquired than the scanning scheme should have been tilted. FIG. 4 illustrates raster pattern 60 that is well suited when acquiring elongated irregular rectangular frames and when acquiring rectangular frames. Raster pattern 60 includes multiple vertical lines 61 (along scan direction 61′ and along opposite scan direction 63′), each representing a center of a strip (out of first till fourth strips 200, 210, 220 and 230), and also includes horizontal lines 62 (along non-scan direction 62′), each representing a movement that enables to scan another strip.

It is noted that a raster pattern can include much more than four vertical lines or fewer than four vertical lines.

Accordingly to another embodiment of the invention the mechanical scanning scheme applies a slightly rotated raster pattern in order to reduce the overlap between stripes (in relation to a non-tilted mechanical scanning scheme).

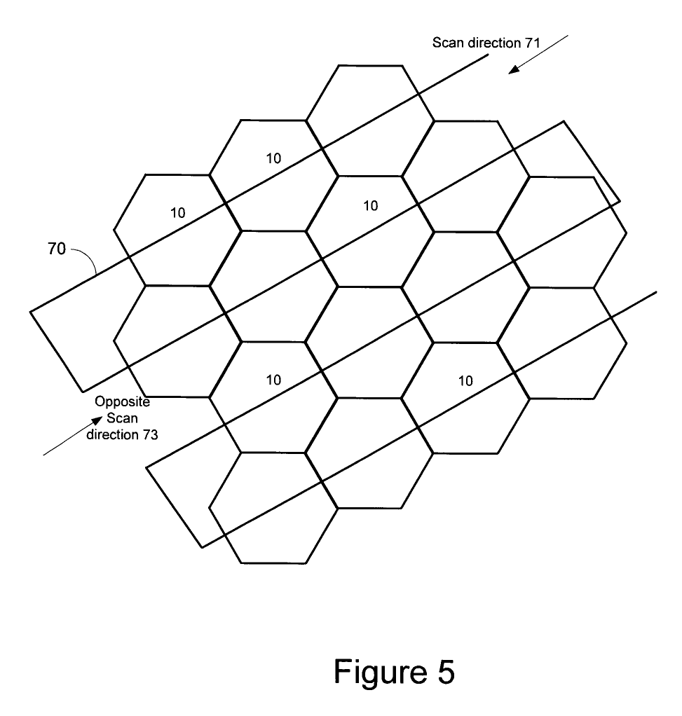

FIG. 5 illustrates another raster pattern 70 that is better suited for scanning regular hexagonal frames 10. Other raster pattern 70 is rotated in relation to raster pattern 60. It also includes multiple scan lines (along scan direction 71 and opposite scan direction) as well as multiple non-scan lines (along non-scan direction 73).

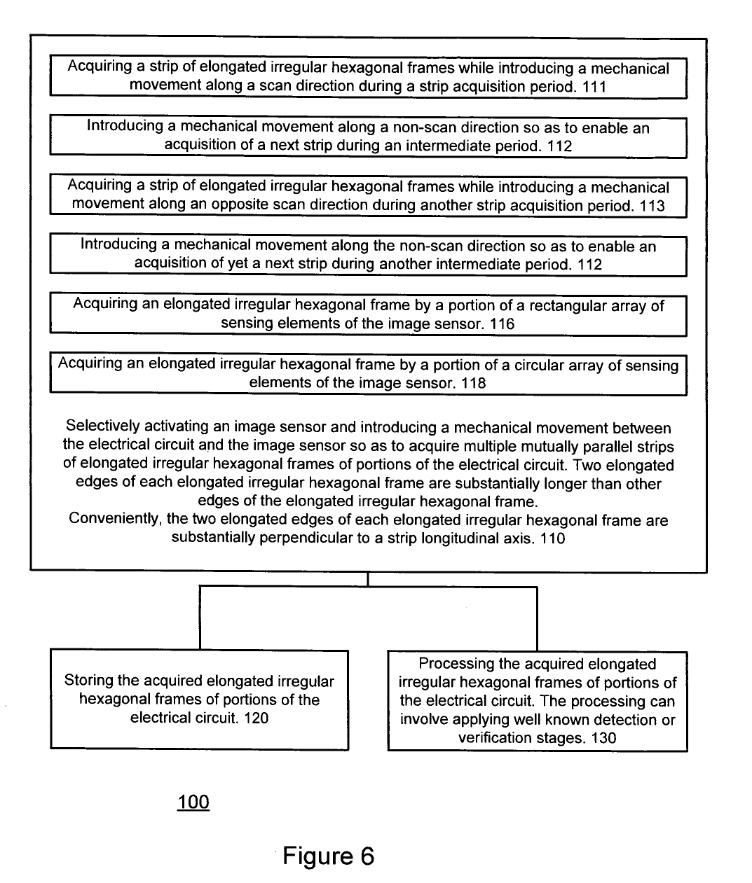

FIG. 6 illustrates method 100 for imaging an electrical circuit according to an embodiment of the invention.

Method 100 starts by stage 110 of selectively activating an image sensor and introducing a mechanical movement between the electrical circuit and the image sensor so as to acquire multiple mutually parallel strips of elongated irregular hexagonal frames of portions of the electrical circuit. Two elongated edges of each elongated irregular hexagonal frame are substantially longer than other edges of the elongated irregular hexagonal frame.

The selective activation refers to the timing of acquisition of each elongated irregular hexagonal frame. The timing of acquisition determines the spatial relationship between different elongated irregular hexagonal frame. Typically, the timing is synchronized with the mechanical movement so as to acquire the desired elongated irregular hexagonal frames.

Conveniently, the two elongated edges of each elongated irregular hexagonal frame are substantially perpendicular to the scan direction.

Conveniently, the two elongated edges of each elongated irregular hexagonal frame are at least 20 percent longer than the other edges of the elongated irregular hexagonal frame.

Conveniently, one other edge of the elongated irregular hexagonal frame is oriented at substantially sixty degrees in relation to the non-scan direction. This is illustrates in FIG. 2.

Conveniently, adjacent strips partially overlap.

Conveniently, stage 110 includes multiple repetitions of the following stages: (i) stage 111 of acquiring a strip of elongated irregular hexagonal frames while introducing a mechanical movement along a scan direction during a strip acquisition period; (ii) stage 112 of introducing a mechanical movement along a non-scan direction so as to enable an acquisition of a next strip during an intermediate period; (iii) stage 113 of acquiring a strip of elongated irregular hexagonal frames while introducing a mechanical movement along an opposite scan direction during another strip acquisition period; (iv) stage 114 of introducing a mechanical movement along the non-scan direction so as to enable an acquisition of yet a next strip during another intermediate period.

Conveniently, the duration of each intermediate period is non-negligible in relation to the duration of a strip acquisition period. It can be longer than one fifth of the duration of the strip acquisition period.

Conveniently, stage 110 includes one of the following stages: (i) stage 116 of acquiring an elongated irregular hexagonal frame by a portion of a rectangular array of sensing elements of the image sensor; or (ii) stage 118 of acquiring an elongated irregular hexagonal frame by a portion of a circular array of sensing elements of the image sensor.

Stage 110 is followed by either one of stages 120 and 130. Stage 120 includes storing the acquired elongated irregular hexagonal frames of portions of the electrical circuit.

Stage 130 includes processing the acquired elongated irregular hexagonal frames of portions of the electrical circuit. The processing can involve applying well known detection or verification stages.

FIG. 6 illustrate system 200 according to an embodiment of the invention.

System 200 includes optics 210 and movement introducer 220. Optics 210 includes light illumination module 212, collection optics 214 and image sensor 216. Imaging sensor is connected to memory unit 230 that in turn is connected to image processor 240. The components of system 200 operate in a coordinated manner in order to image electrical circuit 300 and optionally to evaluate the state of electrical circuit 300.

Movement introducer 220 can introduce movement to optics 210 (or at least to the collection optics 214 and image sensor 216), to electrical circuit 300 or to both. For simplicity of explanation, FIG. 6 illustrates a movement introducer that only moves electrical circuit 300. It can be a heavy (for example—at least one hundred kilogram) mechanical stage,

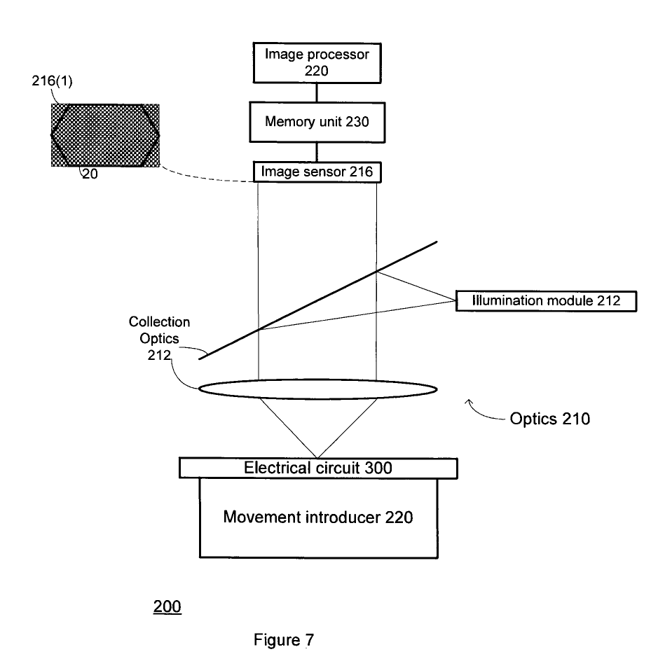

Image sensor 216 is selectively activated while movement introducer 220 introduces a mechanical movement between electrical circuit 300 and image sensor 216 so that image sensor 216 acquires multiple mutually parallel strips of elongated irregular hexagonal frames of portions of electrical circuit 300. Two elongated edges of each elongated irregular hexagonal frame are substantially longer than other edges of the elongated irregular hexagonal frame. FIG. 7 illustrates a rectangular array of sensors 216(1) of image sensor 216 and an elongated irregular hexagonal frame 20 that is captured by that array.

Conveniently the non-scan direction is perpendicular to the plane of the paper [not understood what is “the plane of the paper”] of FIG. 7 while the scan direction is parallel to that plane, but this is not necessarily so.

Conveniently at least one of the following or a combination thereof is fulfilled: (i) the two elongated edges of each elongated irregular hexagonal frame are substantially perpendicular to a scan direction; (ii) the two elongated edges of each elongated irregular hexagonal frame are at least 20 percent longer than the other edges of the elongated irregular hexagonal frame; (iii) one other edge of the elongated irregular hexagonal frame is oriented at substantially sixty degrees in relation to the non-scan direction; (iv) adjacent strips partially overlap; (v) image sensor 216 includes a rectangular array of sensing elements; wherein an elongated irregular hexagonal frame is captured by a portion of the rectangular array of sensing elements; (vii) image sensor 216 includes a circular array of sensing elements; wherein an elongated irregular hexagonal frame is captured by a portion of the circular array of the sensing elements; (viii) image sensor 216 acquires a strip of elongated irregular hexagonal frames while movement introducer 220 introduces a mechanical movement along a scan direction during a strip acquisition period, and movement introducer 220 introduces a mechanical movement along a non-scan direction so as to enable an acquisition of a next strip during an intermediate period; wherein the duration of the intermediate period is non-negligible in relation to a duration of the strip acquisition period; (viii) image sensor 216 acquires a strip of elongated irregular hexagonal frames while movement introducer 220 introduces a mechanical movement along a scan direction during a strip acquisition period and wherein the movement introducer introduces a mechanical movement along a non-scan direction so as to enable an acquisition of a next strip during an intermediate period; wherein the duration of the intermediate period is longer than one fifth of a duration of the strip acquisition period; and (ix) image sensor 216 is an area sensor.

It is noted that the electrical circuit can have a circular shape and a elongated irregular hexagonal frames is much smaller than the electrical circuit.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

We claim:

1. A method for imaging an electrical circuit, the method comprises: selectively activating an image sensor and introducing a mechanical movement between the electrical circuit and the image sensor so as to acquire multiple mutually parallel strips of elongated irregular hexagonal frames of portions of the electrical circuit; wherein two elongated edges of each elongated irregular hexagonal frame are substantially longer than other edges of the elongated irregular hexagonal frame.

2. The method according to claim 1 wherein the two elongated edges of each elongated irregular hexagonal frame are substantially perpendicular to a scan direction.

3. The method according to claim 1 wherein the two elongated edges of each elongated irregular hexagonal frame are at least 20 percent longer than the other edges of the elongated irregular hexagonal frame.

4. The method according to claim 1 wherein one other edge of the elongated irregular hexagonal frame is oriented at substantially sixty degrees in relation to the non-scan direction.

5. The method according to claim 1 wherein adjacent strips partially overlap.

6. The method according to claim 1 comprising acquiring an elongated irregular hexagonal frame by a portion of a rectangular array of sensing elements of the image sensor.

7. The method according to claim 1 comprising acquiring an elongated irregular hexagonal frame by a portion of a circular array of sensing elements of the image sensor.

8. The method according to claim 1 comprising acquiring a strip of elongated irregular hexagonal frames while introducing a mechanical movement along a scan direction during a strip acquisition period and introducing a mechanical movement along a non-scan direction so as to enable an acquisition of a next strip during an intermediate period; wherein the duration of the intermediate period is non-negligible in relation to a duration of the strip acquisition period.

9. The method according to claim 1 comprising acquiring a strip of elongated irregular hexagonal frames while introducing a mechanical movement along a scan direction during a strip acquisition period and introducing a mechanical movement along a non-scan direction so as to enable an acquisition of a next strip during an intermediate period; wherein the duration of the intermediate period is longer than one fifth of a duration of the strip acquisition period.

10. The method according to claim 1 comprising acquiring an elongated irregular hexagonal frame of a portion of the electrical circuit by an area image sensor.

11. A system for imaging an electrical circuit, the system comprises an image sensor and a movement introducer; wherein the image sensor is selectively activated while the movement introducer introduces a mechanical movement between the electrical circuit and the image sensor so that the image sensor acquires multiple mutually parallel strips of elongated irregular hexagonal frames of portions of the electrical circuit; wherein two elongated edges of each elongated irregular hexagonal frame are substantially longer than other edges of the elongated irregular hexagonal frame.

12. The system according to claim 11 wherein the image sensor acquires elongated irregular hexagonal frames of portions of the electrical circuit; wherein the two elongated edges of each elongated irregular hexagonal frame are substantially perpendicular to a scan direction.

13. The system according to claim 11 wherein the image sensor acquires elongated irregular hexagonal frames of portions of the electrical circuit; wherein the two elongated edges of each elongated irregular hexagonal frame are at least 20 percent longer than the other edges of the elongated irregular hexagonal frame.

14. The system according to claim 11 wherein the image sensor acquires elongated irregular hexagonal frames of portions of the electrical circuit; wherein one other edge of the elongated irregular hexagonal frame is oriented at substantially sixty degrees in relation to the non-scan direction.

15. The system according to claim 11 wherein adjacent strips partially overlap.

16. The system according to claim 11 wherein the image sensor comprises a rectangular array of sensing elements; wherein an elongated irregular hexagonal frame is captured by a portion of the rectangular array of sensing elements.

17. The system according to claim 11 wherein the image sensor comprises a circular array of sensing elements; wherein an elongated irregular hexagonal frame is captured by a portion of the circular array of the sensing elements.

18. The system according to claim 11 wherein the image sensor acquires a strip of elongated irregular hexagonal frames while the movement introducer introduces a mechanical movement along a scan direction during a strip acquisition period and wherein the movement introducer introduces a mechanical movement along a non-scan direction so as to enable an acquisition of a next strip during an intermediate period; wherein the duration of the intermediate period is non-negligible in relation to a duration of the strip acquisition period.

19. The system according to claim 11 wherein the image sensor acquires a strip of elongated irregular hexagonal frames while the movement introducer introduces a mechanical movement along a scan direction during a strip acquisition period and wherein the movement introducer introduces a mechanical movement along a non-scan direction so as to enable an acquisition of a next strip during an intermediate period; wherein the duration of the intermediate period is longer than one fifth of a duration of the strip acquisition period.

20. The system according to claim 11 wherein the image sensor is an area sensor.
